(19) United States
(12) Patent Application Publication
(10) Pub. No.: US 2026/0018920 A1
(43) Pub. Date: Jan. 15, 2026

(54) POWER CONVERSION SYSTEM FOR A VEHICLE

(71) Applicant: GM Global Technology Operations LLC, Detroit, MI (US)

(72) Inventors: Mohamed Kamel, Birmingham, MI (US); Khorshed Mohammed Alam, Canton, MI (US); Minh-Khai Nguyen, Troy, MI (US)

(21) Appl. No.: 18/771,178

(22) Filed: Jul. 12, 2024

(51) Int. Cl. H02J 7/04; H02M 3/335

(52) U.S. Cl. CPC H02J 7/04; H02M 3/33507; H02M 3/33573; H02J 2207/20

(57) ABSTRACT

A power conversion system includes a rectifier, a first plurality of switching converters, and a first load including a plurality of first load elements. Each of the first plurality of switching converters has a converter first positive port, a converter first negative port, a converter second positive port, and a converter second negative port. The converter first positive port and the converter first negative port of all of the first plurality of switching converters are connected in series to the rectifier. The converter second positive port of at least one of the first plurality of switching converters is connected to a load element positive port of each of the plurality of first load elements. The converter second negative port of at least one of the first plurality of switching converters is connected to a load element negative port of each of the plurality of first load elements.

### INTRODUCTION

The present disclosure relates to systems for power conversion for a vehicle.

To increase occupant comfort and vehicle performance, vehicles may be equipped with energy storage and power distribution systems. Energy storage and power distribution systems may include rechargeable energy storage systems (RESS) and power electronics systems. The RESS may include high-voltage traction batteries which are configured to store large amounts of energy for use by propulsion systems (e.g., electric motors and/or hybrid-electric motors) of the vehicle and low-voltage auxiliary batteries which are configured to store smaller amounts of energy for use by vehicle accessories (e.g., vehicle lights, climate control systems, entertainment systems, security/alarm systems, and/or the like). The power electronics systems may include power conversion devices (e.g., auxiliary power modules (APM), DC/DC converters, traction inverters, and/or the like) and power switches for converting between high-voltage vehicle systems and the low-voltage vehicle systems. However, current vehicle power conversion devices may require large and/or heavy components designed to withstand high voltages and currents.

Thus, while current vehicle energy storage and power distribution systems and methods achieve their intended purpose, there is a need for a new and improved power conversion system for a vehicle.

### SUMMARY

According to several aspects, a power conversion system includes a rectifier having a plurality of alternating current (AC) ports, a rectifier positive port, and a rectifier negative port. The rectifier positive port and the rectifier negative port provide direct current (DC). The power conversion system further includes a first plurality of switching converters. Each of the first plurality of switching converters has a converter first positive port, a converter first negative port, a converter second positive port, and a converter second negative port. The converter first positive port and the converter first negative port of all of the first plurality of switching converters are connected in series between the rectifier positive port and the rectifier negative port. The power conversion system further includes a first load including a plurality of first load elements. Each of the plurality of first load elements has a load element positive port and a load element negative port. The load element positive port and load element negative port of all of the plurality of first load elements are connected in series to form the first load. The converter second positive port of at least one of the first plurality of switching converters is connected to the load element positive port of each of the plurality of first load elements. The converter second negative port of at least one of the first plurality of switching converters is connected to the load element negative port of each of the plurality of first load elements.

In another aspect of the present disclosure, each of the first plurality of switching converters is a transformer isolated DC/DC converter.

In another aspect of the present disclosure, the power conversion system further includes an enclosure containing one or more of the first plurality of switching converters.

In another aspect of the present disclosure, the power conversion system further includes a second plurality of switching converters. Each of the second plurality of switching converters has a converter first positive port, a converter first negative port, a converter second positive port, and a converter second negative port. The converter second positive port of at least one of the second plurality of switching converters is connected to the load element positive port of each of the plurality of first load elements. The converter second negative port of at least one of the second plurality of switching converters is connected to the load element negative port of each of the plurality of first load elements. The power conversion system further includes a second load. The second load has a second load positive port and a second load negative port. The converter first positive ports of all of the second plurality of switching converters are connected in parallel to the second load positive port of the second load. The converter first negative ports of all of the second plurality of switching converters are connected in parallel to the second load negative port of the second load.

In another aspect of the present disclosure, each of the second plurality of switching converters is a transformer isolated DC/DC converter.

In another aspect of the present disclosure, a first magnetic component of at least one of the first plurality of switching converters is magnetically coupled to a second magnetic component of at least one of the second plurality of switching converters.

In another aspect of the present disclosure, the power conversion system further includes an enclosure containing one or more of the first plurality of switching converters and one or more of the second plurality of switching converters.

In another aspect of the present disclosure, the first load is a high-voltage rechargeable energy storage system (RESS). Each of the plurality of first load elements includes one or more rechargeable battery cells. The second load is a low-voltage auxiliary power system.

In another aspect of the present disclosure, the power conversion system further includes one or more controllers in electrical communication with the first plurality of switching converters and the second plurality of switching converters. The one or more controllers are programmed to control an operation of the first plurality of switching converters to transfer energy between the high-voltage RESS and the rectifier positive port and the rectifier negative port. The one or more controllers are further programmed to control an operation of the second plurality of switching converters to transfer energy between the high-voltage RESS and the low-voltage auxiliary power system.

In another aspect of the present disclosure, the one or more controllers are further programmed to control the operation of the second plurality of switching converters to transfer energy between the plurality of first load elements of the high-voltage RESS to balance the high-voltage RESS.

According to several aspects, a power conversion system for a vehicle is provided. The power conversion system includes a rectifier having a plurality of alternating current (AC) ports, a rectifier positive port, and a rectifier negative port. The rectifier positive port and the rectifier negative port provide direct current (DC). The power conversion system further includes a first plurality of switching converters. Each of the first plurality of switching converters has a converter first positive port, a converter first negative port, a converter second positive port, and a converter second negative port. The converter first positive port and the converter first negative port of all of the first plurality of switching converters are connected in series between the rectifier positive port and the rectifier negative port. Each of the first plurality of switching converters is a transformer isolated DC/DC converter. The power conversion system further includes a first load including a plurality of first load elements. Each of the plurality of first load elements has a load element positive port and a load element negative port. The load element positive port and load element negative port of all of the plurality of first load elements are connected in series to form the first load. The converter second positive port of at least one of the first plurality of switching converters is connected to the load element positive port of each of the plurality of first load elements. The converter second negative port of at least one of the first plurality of switching converters is connected to the load element negative port of each of the plurality of first load elements. The first load is a high-voltage rechargeable energy storage system (RESS). Each of the plurality of first load elements includes one or more rechargeable battery cells.

In another aspect of the present disclosure, the power conversion system further includes one or more controllers in electrical communication with the first plurality of switching converters. The one or more controllers are programmed to control an operation of the first plurality of switching converters to transfer energy between the high-voltage RESS and the rectifier positive port and the rectifier negative port.

In another aspect of the present disclosure, the power conversion system further includes a second plurality of switching converters. Each of the second plurality of switching converters has a converter first positive port, a converter first negative port, a converter second positive port, and a converter second negative port. The converter second positive port of at least one of the second plurality of switching converters is connected to the load element positive port of each of the plurality of first load elements. The converter second negative port of at least one of the second plurality of switching converters is connected to the load element negative port of each of the plurality of first load elements. Each of the second plurality of switching converters is a transformer isolated DC/DC converter. The power conversion system further includes a second load. The second load has a second load positive port and a second load negative port. The converter first positive ports of all of the second plurality of switching converters are connected in parallel to the second load positive port of the second load. The converter first negative ports of all of the second plurality of switching converters are connected in parallel to the second load negative port of the second load. The second load is a low-voltage auxiliary power system.

In another aspect of the present disclosure, the one or more controllers are further programmed to control an operation of the second plurality of switching converters to transfer energy between the high-voltage RESS and the low-voltage auxiliary power system.

In another aspect of the present disclosure, the one or more controllers are further programmed to control the operation of a first converter of the second plurality of switching converters to transfer energy between the plurality of first load elements of the high-voltage RESS at a first rate. The one or more controllers are further programmed to control the operation of a second converter of the second plurality of switching converters to transfer energy between the plurality of first load elements of the high-voltage RESS at a second rate, wherein the second rate is different from the first rate.

In another aspect of the present disclosure, at least one of the first plurality of switching converters is magnetically coupled to at least one of the second plurality of switching converters using a multiple-winding isolation transformer.

In another aspect of the present disclosure, the power conversion system further includes an enclosure containing one or more of the first plurality of switching converters and one or more of the second plurality of switching converters.

According to several aspects, a power conversion system for a vehicle is provided. The power conversion system includes a rectifier having a plurality of alternating current (AC) ports, a rectifier positive port, and a rectifier negative port. The rectifier positive port and the rectifier negative port provide direct current (DC). The power conversion system further includes a first plurality of switching converters. Each of the first plurality of switching converters has a converter first positive port, a converter first negative port, a converter second positive port, and a converter second negative port. The converter first positive port and the converter first negative port of all of the first plurality of switching converters are connected in series between the rectifier positive port and the rectifier negative port. Each of the first plurality of switching converters is a transformer isolated DC/DC converter. The power conversion system further includes a first load including a plurality of first load elements. Each of the plurality of first load elements has a load element positive port and a load element negative port. The load element positive port and load element negative port of all of the plurality of first load elements are connected in series to form the first load. The converter second positive port of at least one of the first plurality of switching converters is connected to the load element positive port of each of the plurality of first load elements. The converter second negative port of at least one of the first plurality of switching converters is connected to the load element negative port of each of the plurality of first load elements. The first load is a high-voltage rechargeable energy storage system (RESS). Each of the plurality of first load elements includes one or more rechargeable battery cells. The power conversion system further includes a second plurality of switching converters. Each of the second plurality of switching converters has a converter first positive port, a converter first negative port, a converter second positive port, and a converter second negative port. The converter second positive port of at least one of the second plurality of switching converters is connected to the load element positive port of each of the plurality of first load elements. The converter second negative port of at least one of the second plurality of switching converters is connected to the load element negative port of each of the plurality of first load elements. Each of the second plurality of switching converters is a transformer isolated DC/DC converter. The power conversion system further includes a second load. The second load has a second load positive port and a second load negative port. The converter first positive ports of all of the second plurality of switching converters are connected in parallel to the second load positive port of the second load. The converter first negative ports of all of the second plurality of switching converters are connected in parallel to the second load negative port of the second load. The second load is a low-voltage auxiliary power system.

In another aspect of the present disclosure, the power conversion system further includes one or more controllers in electrical communication with the first plurality of switching converters. The one or more controllers are programmed to control an operation of the first plurality of switching converters to transfer energy between the high-voltage RESS and the rectifier positive port and the rectifier negative port. The one or more controllers are further programmed to control an operation of the second plurality of switching converters to transfer energy between the high-voltage RESS and the low-voltage auxiliary power system. The one or more controllers are further programmed to control the operation of the second plurality of switching converters to transfer energy between the plurality of first load elements of the high-voltage RESS to balance the high-voltage RESS.

In another aspect of the present disclosure, a first magnetic component of at least one of the first plurality of switching converters is magnetically coupled to a second magnetic component of at least one of the second plurality of switching converters.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a schematic diagram of a power conversion system for a vehicle, according to an exemplary embodiment;

FIG. 2 is a schematic diagram of the power conversion system including a power system, according to an exemplary embodiment;

FIG. 3A is a schematic diagram of a first exemplary embodiment of a portion of the power system, according to an exemplary embodiment; and

FIG. 3B is a schematic diagram of a second exemplary embodiment of the portion of the power system, according to an exemplary embodiment.

### DETAILED DESCRIPTION

The following description is merely exemplary in nature and is not intended to limit the present disclosure, application, or uses.

In the pursuit of increased electric and/or hybrid-electric vehicle (xEV) performance and efficiency, xEV power systems must contend with ever-increasing power transfer requirements, including, for example, increasing battery pack voltages. Accordingly, the present disclosure provides a new and improved power conversion system for a vehicle which is configured with a modular design, and which is configured to allow for reduced voltage and/or power requirements for individual components.

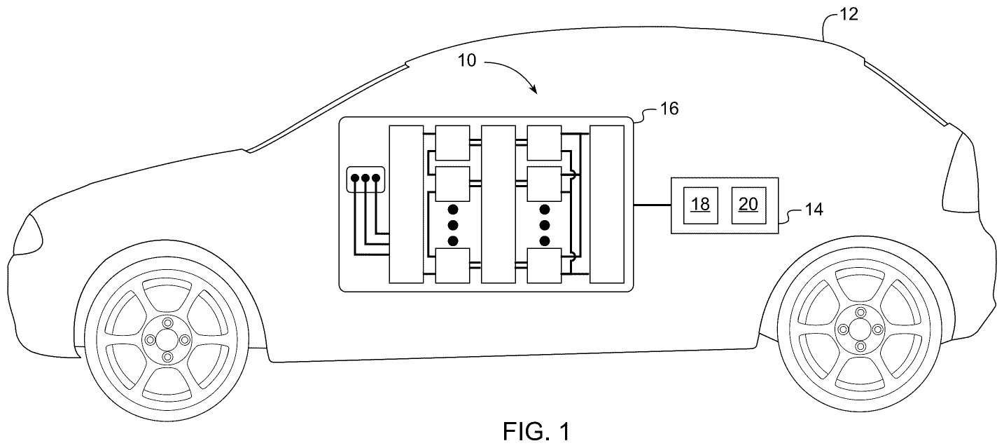

Referring to FIG. 1, a power conversion system for a vehicle is illustrated and generally indicated by reference number 10. The power conversion system 10 is shown with an exemplary vehicle 12. While a passenger vehicle is illustrated, it should be appreciated that the vehicle 12 may be any type of vehicle without departing from the scope of the present disclosure. The power conversion system 10 generally includes a controller 14 and a power system 16.

The controller 14 is used to operate and control the power system 16, as will be described below. The controller 14 includes at least one processor 18 and a non-transitory computer readable storage device or media 20. The processor 18 may be a custom made or commercially available processor, a central processing unit (CPU), a graphics processing unit (GPU), an auxiliary processor among several processors associated with the controller 14, a semiconductor-based microprocessor (in the form of a microchip or chip set), a macroprocessor, a combination thereof, or generally a device for executing instructions.

The computer readable storage device or media 20 may include volatile and nonvolatile storage in read-only memory (ROM), random-access memory (RAM), and keep-alive memory (KAM), for example. KAM is a persistent or non-volatile memory that may be used to store various operating variables while the processor 18 is powered down. The computer-readable storage device or media 20 may be implemented using a number of memory devices such as PROMs (programmable read-only memory), EPROMs (electrically PROM), EEPROMs (electrically erasable PROM), flash memory, or another electric, magnetic, optical, or combination memory devices capable of storing data, some of which represent executable instructions, used by the controller 14 to control various systems of the vehicle 12.

The controller 14 may also consist of multiple controllers which are in electrical communication with each other. The controller 14 may be inter-connected with additional systems and/or controllers of the vehicle 12, allowing the controller 14 to access data such as, for example, speed, acceleration, braking, and steering angle of the vehicle 12.

The controller 14 is in electrical communication with the power system 16. In an exemplary embodiment, the electrical communication is established using, for example, a CAN network, a FLEXRAY network, a local area network (e.g., WiFi, ethernet, and the like), a serial peripheral interface (SPI) network, analog measurement/communication/control, or the like. It should be understood that various additional wired and wireless techniques and communication protocols for communicating with the controller 14 are within the scope of the present disclosure. It should further be understood that, in the scope of the present disclosure, electrical communication also includes power and/or energy transfer between electrical devices (e.g., using conducting wires and/or wireless power transmission techniques).

In a non-limiting example, the controller 14 establishes a relatively fast communication link (e.g., on the order of one microsecond) with the power system 16 and a relatively slower communication link (e.g., on the order of tens or hundreds of milliseconds) with the additional systems and/or controllers of the vehicle 12 as compared to the communication link with the power system 16.

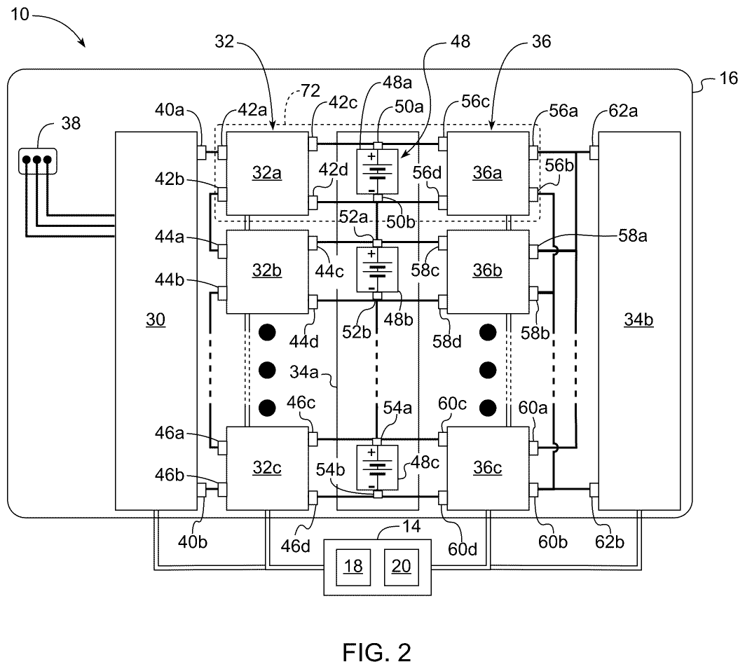

Referring to FIG. 2, a schematic diagram of the power conversion system 10 including the power system 16 is shown. The power system 16 includes a rectifier 30, a first plurality of switching converters 32, a first load 34a, a second plurality of switching converters 36, and a second load 34b.

The rectifier 30 is used to convert alternating current (AC) to direct current (DC). In an exemplary embodiment, the rectifier 30 is a bridge rectifier. In a non-limiting example, the bridge rectifier includes four diodes (not shown) arranged in a bridge configuration. The diodes allow current to flow only in one direction, rectifying an AC input to produce a DC output. In another exemplary embodiment, the rectifier 30 is a controlled rectifier including one or more controllable semiconductor devices (e.g., transistors, thyristors, and/or the like) in electrical communication with the controller 14. The one or more controllable semiconductor devices are switched by the controller 14 to rectify the AC input to produce the DC output. In a non-limiting example, the rectifier 30 is configured to rectify AC inputs having a frequency of 49-62 hertz (Hz) to produce the DC output.

In a non-limiting example, the rectifier 30 includes a plurality of alternating current (AC) ports 38 for receiving the AC input and a rectifier positive port 40a and a rectifier negative port 40b for supplying the DC output. It should be understood that the rectifier 30 may include additional capabilities, systems, and/or circuits such as, for example, fault protection, power factor correction (PFC), power draw regulation, inverter(s) for DC to AC conversion (i.e., capability for bi-directional energy transfer between the plurality of AC ports 38 and the rectifier positive port 40a and the rectifier negative port 40b), and/or the like without departing from the scope of the present disclosure. The rectifier 30 is in electrical communication with the controller 14 to control an operation of the rectifier 30 (e.g., an activation state, a switching frequency, and/or the like).

The first plurality of switching converters 32 are used to convert and/or regulate power from the rectifier 30 and supply power to the first load 34a. In some embodiments, the first plurality of switching converters 32 are additionally used to supply power from the first load 34a to the rectifier 30. The first plurality of switching converters 32 includes at least a first switching converter 32a, a second switching converter 32b, and a third switching converter 32c. While three switching converters are shown in FIG. 2, it should be understood that the first plurality of switching converters 32 may include any number of switching converters. In an exemplary embodiment, the first plurality of switching converters 32 are transformer isolated DC/DC converters (e.g., flyback converters, forward converters, and/or other types of transformer isolated switching converters). Each of the first plurality of switching converters 32 is in electrical communication with the controller 14 to control an operation of each of the first plurality of switching converters 32 (e.g., activation state, switching frequency, duty cycle, and/or the like). The first plurality of switching converters 32 are connected in series between the rectifier positive port 40a and the rectifier negative port 40b, as will be discussed in greater detail below.

The first switching converter 32a has a first converter first positive port 42a, a first converter first negative port 42b, a first converter second positive port 42c, and a first converter second negative port 42d. In an exemplary embodiment, the first switching converter 32a is operable to transmit energy from the first converter first positive port 42a and the first converter first negative port 42b to the first converter second positive port 42c and the first converter second negative port 42d. In another exemplary embodiment, the first switching converter 32a is also operable to transmit energy from the first converter second positive port 42c and the first converter second negative port 42d to the first converter first positive port 42a and the first converter first negative port 42b. The first converter first positive port 42a is connected to the rectifier positive port 40a.

The second switching converter 32b has a second converter first positive port 44a, a second converter first negative port 44b, a second converter second positive port 44c, and a second converter second negative port 44d. In an exemplary embodiment, the second switching converter 32b is operable to transmit energy from the second converter first positive port 44a and the second converter first negative port 44b to the second converter second positive port 44c and the second converter second negative port 44d. In another exemplary embodiment, the second switching converter 32b is also operable to transmit energy from the second converter second positive port 44c and the second converter second negative port 44d to the second converter first positive port 44a and the second converter first negative port 44b. The second converter first positive port 44a is connected to the first converter first negative port 42b.

The third switching converter 32c has a third converter first positive port 46a, a third converter first negative port 46b, a third converter second positive port 46c, and a third converter second negative port 46d. In an exemplary embodiment, the third switching converter 32c is operable to transmit energy from the third converter first positive port 46a and the third converter first negative port 46b to the third converter second positive port 46c and the third converter second negative port 46d. In another exemplary embodiment, the third switching converter 32c is also operable to transmit energy from the third converter second positive port 46c and the third converter second negative port 46d to the third converter first positive port 46a and the third converter first negative port 46b. The third converter first positive port 46a is connected to the second converter first negative port 44b. The third converter first negative port 46b is connected to the rectifier negative port 40b. It should be understood that any number of additional switching converters of the first plurality of switching converters 32 may be connected in series between the second switching converter 32b and the third switching converter 32c without departing from the scope of the present disclosure. In an exemplary embodiment, the first plurality of switching converters 32 are designed and controlled such that each of the first plurality of switching converters 32 has an approximately equal voltage across the converter first positive ports (e.g., the first converter first positive port 42a) and the converter first negative ports (e.g., the first converter first negative port 42b):

$${v}_{c} = \frac{{v}_{r}}{n} \qquad ( 1 )$$

where v_{c} is the voltage across the converter first positive ports and the converter first negative ports of each of the first plurality of switching converters 32, vᵣ is a voltage measured between the rectifier positive port 40a and the rectifier negative port 40b, and n is a quantity of switching converters in the first plurality of switching converters 32 (e.g., three, as shown in FIG. 2).

The first load 34a is used to store energy at a high voltage (e.g., between 100 volts and 800 volts) for use in propelling the vehicle 12. In an exemplary embodiment, the first load 34a is a high-voltage rechargeable energy storage system (RESS). In an exemplary embodiment, the first load 34a includes a plurality of first load elements 48 including at least a first load element 48a, a second load element 48b, and a third load element 48c. While three load elements are shown in FIG. 2, it should be understood that the plurality of first load elements 48 may include any number of load elements. In a non-limiting example, the each of the plurality of first load elements 48 includes one or more rechargeable battery cells (e.g., lithium-ion (Li-ion) cells, lithium polymer (LiPo) cells, lithium iron phosphate (LiFePO₄) cells, lithium nickel manganese cobalt oxide (NMC) cells, lithium nickel cobalt aluminum oxide (NCA) cells, lithium manganese oxide (LMO) cells, lithium cobalt oxide (LCO) cells, lithium titanate (LTO) cells, and/or the like) connected in parallel or series. The plurality of first load elements 48 are connected in series to form the first load 34a, as will be discussed in greater detail below.

The first load element 48a includes one or more rechargeable battery cells and has a first load element positive port 50a and a first load element negative port 50b. The first load element positive port 50a is an overall positive port of the first load 34a and is connected to the first converter second positive port 42c. The first load element negative port 50b is connected to the first converter second negative port 42d. The second load element 48b includes one or more rechargeable battery cells and has a second load element positive port 52a and a second load element negative port 52b. The second load element positive port 52a is connected to the first load element negative port 50b and the second converter second positive port 44c. The second load element negative port 52b is connected to the second converter second negative port 44d.

The third load element 48c includes one or more rechargeable battery cells and has a third load element positive port 54a and a third load element negative port 54b. The third load element positive port 54a is connected to the second load element negative port 52b and the third converter second positive port 46c. The third load element negative port 54b is an overall negative port of the first load 34a and is connected to the third converter second negative port 46d. It should be understood that any number of additional load elements of the plurality of first load elements 48 may be connected in series between the second load element 48b and the third load element 48c and connected to the first plurality of switching converters 32 in a similar manner as described above without departing from the scope of the present disclosure.

The second plurality of switching converters 36 are used to convert and/or regulate power from the first load 34a and supply power to the second load 34b. In some embodiments, the second plurality of switching converters 36 are additionally used to supply power from the second load 34b to the first load 34a. The second plurality of switching converters 36 includes at least a fourth switching converter 36a, a fifth switching converter 36b, and a sixth switching converter 36c. While three switching converters are shown in FIG. 2, it should be understood that the second plurality of switching converters 36 may include any number of switching converters. In an exemplary embodiment, the second plurality of switching converters 36 are transformer isolated DC/DC converters (e.g., flyback converters, forward converters, and/or other types of transformer isolated switching converters). Each of the second plurality of switching converters 36 is in electrical communication with the controller 14 to control an operation of each of the second plurality of switching converters 36 (e.g., activation state, switching frequency, duty cycle, and/or the like). The second plurality of switching converters 36 are connected in parallel to the second load 34b, as will be discussed in greater detail below. In an exemplary embodiment, the second plurality of switching converters 36 are configured for lower power operation relative to the first plurality of switching converters 32.

The fourth switching converter 36a has a fourth converter first positive port 56a, a fourth converter first negative port 56b, a fourth converter second positive port 56c, and a fourth converter second negative port 56d. In an exemplary embodiment, the fourth switching converter 36a is operable to transmit energy from the fourth converter first positive port 56a and the fourth converter first negative port 56b to the fourth converter second positive port 56c and the fourth converter second negative port 56d. In another exemplary embodiment, the fourth switching converter 36a is also operable to transmit energy from the fourth converter second positive port 56c and the fourth converter second negative port 56d to the fourth converter first positive port 56a and the fourth converter first negative port 56b. The fourth converter second positive port 56c is connected to the first load element positive port 50a. The fourth converter second negative port 56d is connected to the first load element negative port 50b.

The fifth switching converter 36b has a fifth converter first positive port 58a, a fifth converter first negative port 58b, a fifth converter second positive port 58c, and a fifth converter second negative port 58d. In an exemplary embodiment, the fifth switching converter 36b is operable to transmit energy from the fifth converter first positive port 58a and the fifth converter first negative port 58b to the fifth converter second positive port 58c and the fifth converter second negative port 58d. In another exemplary embodiment, the fifth switching converter 36b is also operable to transmit energy from the fifth converter second positive port 58c and the fifth converter second negative port 58d to the fifth converter first positive port 58a and the fifth converter first negative port 58b. The fifth converter second positive port 58c is connected to the second load element positive port 52a. The fifth converter second negative port 58d is connected to the second load element negative port 52b.

The sixth switching converter 36c has a sixth converter first positive port 60a, a sixth converter first negative port 60b, a sixth converter second positive port 60c, and a sixth converter second negative port 60d. In an exemplary embodiment, the sixth switching converter 36c is operable to transmit energy from the sixth converter first positive port 60a and the sixth converter first negative port 60b to the sixth converter second positive port 60c and the sixth converter second negative port 60d. In another exemplary embodiment, the sixth switching converter 36c is also operable to transmit energy from the sixth converter second positive port 60c and the sixth converter second negative port 60d to the sixth converter first positive port 60a and the sixth converter first negative port 60b. The sixth converter second positive port 60c is connected to the third load element positive port 54a. The sixth converter second negative port 60d is connected to the third load element negative port 54b. It should be understood that any number of additional switching converters of the second plurality of switching converters 36 may be connected in series between the fifth switching converter 36b and the sixth switching converter 36c and connected to the plurality of first load elements 48 in a similar manner as described above without departing from the scope of the present disclosure.

The second load 34b is used to store energy at a low voltage (e.g., 12 volts) for use to power auxiliary systems of the vehicle 12 (e.g., interior/exterior lights, climate control systems, infotainment systems, vehicle control units, alarm systems, and/or the like). In an exemplary embodiment, the second load 34b is a low-voltage auxiliary power system including a rechargeable energy storage system (RESS) with one or more rechargeable battery cells (e.g., lithium-ion (Li-ion) cells, lead-acid cells, and/or the like) connected in parallel or series. The second load 34b has a second load positive port 62a and a second load negative port 62b. The second load positive port 62a is connected in parallel to the fourth converter first positive port 56a, the fifth converter first positive port 58a, and the sixth converter first positive port 60a. The second load negative port 62b is connected in parallel to the fourth converter first negative port 56b, the fifth converter first negative port 58b, and the sixth converter first negative port 60b.

In an exemplary embodiment, the controller 14 is programmed to control an operation of the first plurality of switching converters 32 to transfer energy between the first load 34a and the rectifier positive port 40a and the rectifier negative port 40b. In a non-limiting example, when an AC electrical grid is connected to the plurality of AC ports 38 of the rectifier 30, the first plurality of switching converters 32 transfer energy from the rectifier 30 to the first load 34a (e.g., to charge the high-voltage RESS). In another non-limiting example, when an AC electrical load is connected to the plurality of AC ports 38 of the rectifier 30, the first plurality of switching converters 32 transfer energy from the first load 34a (e.g., the high-voltage RESS) to the rectifier 30 (e.g., to provide power to the AC electrical load).

In a non-limiting example, to control the operation of the first plurality of switching converters 32 to transfer energy between the first load 34a and the rectifier positive port 40a and the rectifier negative port 40b, the controller 14 adjusts an activation state, a switching frequency, a duty cycle, and/or the like of the first plurality of switching converters 32 using a closed-loop feedback control system based on voltages across the converter first positive ports (e.g., the first converter first positive port 42a) and the converter first negative ports (e.g., the first converter first negative port 42b) and based on voltages across the converter second positive ports (e.g., the first converter second positive port 42c) and the converter second negative ports (e.g., the first converter second negative port 42d).

In another exemplary embodiment, the controller 14 is programmed to control an operation of the second plurality of switching converters 36 to transfer energy between the first load 34a and the second load 34b. In a non-limiting example, the second plurality of switching converters 36 provide energy to power auxiliary systems of the vehicle 12 (e.g., interior/exterior lights, climate control systems, infotainment systems, vehicle control units, and/or the like) by transferring energy from the first load 34a to the second load 34b.

In a non-limiting example, to control the operation of the second plurality of switching converters 36 to transfer energy between the first load 34a and the second load 34b, the controller 14 adjusts an activation state, a switching frequency, a duty cycle, and/or the like of the second plurality of switching converters 36 using a closed-loop feedback control system based on voltages across the converter first positive ports (e.g., the fourth converter first positive port 56a) and the converter first negative ports (e.g., the fourth converter first negative port 56b) and based on voltages across the converter second positive ports (e.g., the fourth converter second positive port 56c) and the converter second negative ports (e.g., the fourth converter second negative port 56d).

In another exemplary embodiment, the controller 14 is programmed to control an operation of the second plurality of switching converters 36 to transfer energy between the plurality of first load elements 48 of the first load 34a. In a non-limiting example, the second plurality of switching converters 36 are used to balance rechargeable battery cells or groups of rechargeable battery cells of the high-voltage RESS.

In a non-limiting example, to control the operation of the second plurality of switching converters 36 to balance the high-voltage RESS, the controller 14 adjusts an activation state, a switching frequency, a duty cycle, and/or the like of the second plurality of switching converters 36 using a closed-loop feedback control system based on voltages across the converter first positive ports (e.g., the fourth converter first positive port 56a) and the converter first negative ports (e.g., the fourth converter first negative port 56b) and based on voltages across the converter second positive ports (e.g., the fourth converter second positive port 56c) and the converter second negative ports (e.g., the fourth converter second negative port 56d). In a non-limiting example, the second plurality of switching converters 36 are controlled to transfer energy from rechargeable battery cells having a relatively higher state of charge to rechargeable battery cells having a relatively lower state of charge using the second load 34b as a buffer for energy storage and transfer during balancing.

In a non-limiting example, to control the operation of the second plurality of switching converters 36 to balance the high-voltage RESS, the controller 14 adjusts an activation state, a switching frequency, a duty cycle, and/or the like of the second plurality of switching converters 36 such that a first converter of the second plurality of switching converters 36 (e.g., the fourth switching converter 36a) transfers energy between the plurality of first load elements 48 of the first load 34a at a first rate (e.g., ten watts). The controller 14 further controls the second plurality of switching converters 36 such that a second converter of the second plurality of switching converters 36 (e.g., the fifth switching converter 36b) transfers energy between the plurality of first load elements 48 of the first load 34a at a second rate (e.g., fifteen watts), where the second rate is different from the first rate.

It should be understood that the techniques for controlling the first plurality of switching converters 32 and the second plurality of switching converters 36 discussed above are merely exemplary in nature, and that alternative and/or additional control methods may be used without departing from the scope of the present disclosure.

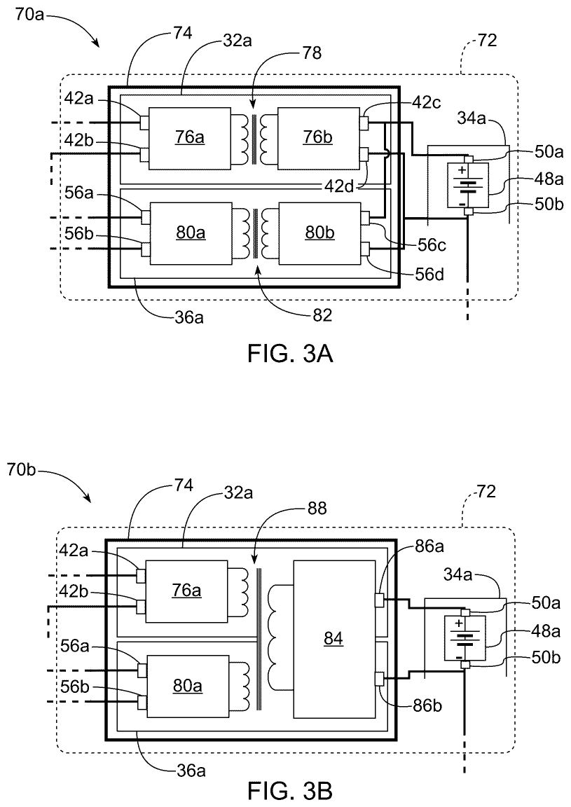

Referring to FIG. 3A, a first exemplary embodiment 70a of a portion 72 of the power system 16 is shown. The portion 72 includes the first switching converter 32a, the fourth switching converter 36a, an enclosure 74 containing the first switching converter 32a and the fourth switching converter 36a, and a portion of the first load 34a including the first load element 48a.

In the first exemplary embodiment 70a, the first switching converter 32a includes a first converter primary side 76a, a first converter secondary side 76b, and a first converter isolation transformer 78 electromagnetically coupling the first converter primary side 76a and the first converter secondary side 76b. The first converter primary side 76a includes the first converter first positive port 42a, the first converter first negative port 42b, and power electronic components such as, for example, inductors, capacitors, semiconductor switches, diodes, and/or the like. The first converter first positive port 42a and the first converter first negative port 42b are connected to other components of the power system 16 as described above in reference to FIG. 2.

The first converter secondary side 76b includes the first converter second positive port 42c, the first converter second negative port 42d, and power electronic components such as, for example, inductors, capacitors, semiconductor switches, diodes, and/or the like. The first converter second positive port 42c and the first converter second negative port 42d are connected to other components of the power system 16 as described above in reference to FIG. 2. The first converter isolation transformer 78 includes a primary coil connected to the first converter primary side 76a, a secondary coil connected to the first converter secondary side 76b, and a magnetic core (e.g., an air core, a ferromagnetic core, and/or the like) electromagnetically coupling the primary coil and the secondary coil. The primary coil and the secondary coil are considered to be magnetic components. In the scope of the present disclosure, a magnetic component is a circuit component which utilizes magnetic fields for the purpose of energy storage, transfer, transmission, or coupling.

The fourth switching converter 36a includes a fourth converter primary side 80a, a fourth converter secondary side 80b, and a fourth converter isolation transformer 82 electromagnetically coupling the fourth converter primary side 80a and the fourth converter secondary side 80b. The fourth converter primary side 80a includes the fourth converter first positive port 56a, the fourth converter first negative port 56b, and power electronic components such as, for example, inductors, capacitors, semiconductor switches, diodes, and/or the like. The fourth converter first positive port 56a and the fourth converter first negative port 56b are connected to other components of the power system 16 as described above in reference to FIG. 2.

The fourth converter secondary side 80b includes the fourth converter second positive port 56c, the fourth converter second negative port 56d, and power electronic components such as, for example, inductors, capacitors, semiconductor switches, diodes, and/or the like. The fourth converter second positive port 56c and the fourth converter second negative port 56d are connected to other components of the power system 16 as described above in reference to FIG. 2. The fourth converter isolation transformer 82 includes a primary coil connected to the fourth converter primary side 80a, a secondary coil connected to the fourth converter secondary side 80b, and a magnetic core (e.g., an air core, a ferromagnetic core, and/or the like) electromagnetically coupling the primary coil and the secondary coil. The primary coil and the secondary coil are considered to be magnetic components. In the scope of the present disclosure, a magnetic component is a circuit component which utilizes magnetic fields for the purpose of energy storage, transfer, transmission, or coupling.

The enclosure 74 provides electrical isolation, mechanical isolation, and/or ingress protection to the first switching converter 32a and the fourth switching converter 36a. In a non-limiting example, the enclosure 74 includes one or more plastic, metal, and/or composite enclosures providing electrical isolation, mechanical isolation (e.g., vibration mitigation), protection from water ingress, protection from dust ingress, and/or the like. In another non-limiting example, the enclosure 74 is filled with a potting compound (e.g., a thermosetting plastic, silicone, or rubber and/or an epoxy resin) to exclude dust and water and isolate the first switching converter 32a and the fourth switching converter 36a from vibration. In some embodiments, the enclosure 74 includes two separate compartments or two separate, independent enclosures, each containing one of the first switching converter 32a and the fourth switching converter 36a.

It should be understood that the first exemplary embodiment 70a of the portion 72 of the power system 16 described above is applicable to the entire power system 16, including the first plurality of switching converters 32, the second plurality of switching converters 36, and the plurality of first load elements 48 of the first load 34a. In an exemplary embodiment, the power system 16 is realized as a plurality of modules like the first exemplary embodiment 70a of the portion 72 connected together as described in reference to FIG. 2.

Referring to FIG. 3B, a second exemplary embodiment 70b of the portion 72 of the power system 16 is shown. The portion 72 includes the first switching converter 32a, the fourth switching converter 36a, the enclosure 74 containing the first switching converter 32a and the fourth switching converter 36a, and the portion of the first load 34a including the first load element 48a.

In the second exemplary embodiment 70b, the first switching converter 32a includes the first converter primary side 76a. The first converter primary side 76a includes the first converter first positive port 42a, the first converter first negative port 42b, and power electronic components such as, for example, inductors, capacitors, semiconductor switches, diodes, and/or the like. The first converter first positive port 42a and the first converter first negative port 42b are connected to other components of the power system 16 as described above in reference to FIG. 2.

The fourth switching converter 36a includes the fourth converter primary side 80a. The fourth converter primary side 80a includes the fourth converter first positive port 56a, the fourth converter first negative port 56b, and power electronic components such as, for example, inductors, capacitors, semiconductor switches, diodes, and/or the like. The fourth converter first positive port 56a and the fourth converter first negative port 56b are connected to other components of the power system 16 as described above in reference to FIG. 2.

In the second exemplary embodiment 70b, the first switching converter 32a and the fourth switching converter 36a share a common coupled secondary side 84. The common coupled secondary side 84 includes a common coupled secondary side positive port 86a, a common coupled secondary side negative port 86b, and power electronic components such as, for example, inductors, capacitors, semiconductor switches, diodes, and/or the like. The common coupled secondary side positive port 86a is connected to the first load element positive port 50a. The common coupled secondary side negative port 86b is connected to the first load element negative port 50b.

The first converter primary side 76a and the fourth converter primary side 80a are coupled to the common coupled secondary side 84 using a multiple-winding isolation transformer 88. The multiple-winding isolation transformer 88 includes a first primary coil connected to the first converter primary side 76a, a second primary coil connected to the fourth converter primary side 80a, a secondary coil connected to the common coupled secondary side 84, and a common magnetic core (e.g., an air core, a ferromagnetic core, and/or the like) electromagnetically coupling the first primary coil, the second primary coil, and the secondary coil. The first primary coil, the second primary coil, and the secondary coil are considered to be magnetic components. In the scope of the present disclosure, a magnetic component is a circuit component which utilizes magnetic fields for the purpose of energy storage, transfer, transmission, or coupling.

The enclosure 74 provides electrical isolation, mechanical isolation, and/or ingress protection to the first switching converter 32a, the fourth switching converter 36a, and the common coupled secondary side 84 as discussed above in reference to FIG. 3A.

It should be understood that the second exemplary embodiment 70b of the portion 72 of the power system 16 described above is applicable to the entire power system 16, including the first plurality of switching converters 32, the second plurality of switching converters 36, and the plurality of first load elements 48 of the first load 34a. In an exemplary embodiment, the power system 16 is realized as a plurality of modules like the second exemplary embodiment 70b of the portion 72 connected together as described in reference to FIG. 2.

The power conversion system 10 of the present disclosure offers several advantages. By connecting first plurality of switching converters 32 in series between the rectifier positive port 40a and the rectifier negative port 40b, each of the first plurality of switching converters 32 are exposed to a lower voltage across the converter first positive ports (e.g., the first converter first positive port 42a) and the converter first negative ports (e.g., the first converter first negative port 42b), allowing for use of more efficient and economical components. Furthermore, by connecting each of the second plurality of switching converters 36 to one of the plurality of first load elements 48, each of the first plurality of switching converters 32 are exposed to a lower voltage across the converter second positive ports (e.g., the fourth converter second positive port 56c) and the converter second negative ports (e.g., the fourth converter second negative port 56d). Additionally, the power conversion system 10 of the present disclosure is modular and may be adapted for use with high-voltage RESS systems (i.e., the first load 34a) having various voltages, capacities, and power delivery capabilities.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A power conversion system comprising:
a rectifier having a plurality of alternating current (AC) ports, a rectifier positive port, and a rectifier negative port, wherein the rectifier positive port and the rectifier negative port provide direct current (DC);
a first plurality of switching converters, wherein each of the first plurality of switching converters has a converter first positive port, a converter first negative port, a converter second positive port, and a converter second negative port, and wherein the converter first positive port and the converter first negative port of all of the first plurality of switching converters are connected in series between the rectifier positive port and the rectifier negative port; and
a first load including a plurality of first load elements, wherein each of the plurality of first load elements has a load element positive port and a load element negative port, wherein the load element positive port and load element negative port of all of the plurality of first load elements are connected in series to form the first load, wherein the converter second positive port of at least one of the first plurality of switching converters is connected to the load element positive port of each of the plurality of first load elements, and wherein the converter second negative port of at least one of the first plurality of switching converters is connected to the load element negative port of each of the plurality of first load elements.

2. The power conversion system of claim 1, wherein each of the first plurality of switching converters is a transformer isolated DC/DC converter.

3. The power conversion system of claim 2, further comprising an enclosure containing one or more of the first plurality of switching converters.

4. The power conversion system of claim 2, further comprising:
a second plurality of switching converters, wherein each of the second plurality of switching converters has a converter first positive port, a converter first negative port, a converter second positive port, and a converter second negative port, wherein the converter second positive port of at least one of the second plurality of switching converters is connected to the load element positive port of each of the plurality of first load elements, and wherein the converter second negative port of at least one of the second plurality of switching converters is connected to the load element negative port of each of the plurality of first load elements; and
a second load, wherein the second load has a second load positive port and a second load negative port, wherein the converter first positive ports of all of the second plurality of switching converters are connected in parallel to the second load positive port of the second load, and wherein the converter first negative ports of all of the second plurality of switching converters are connected in parallel to the second load negative port of the second load.

5. The power conversion system of claim 4, wherein each of the second plurality of switching converters is a transformer isolated DC/DC converter.

6. The power conversion system of claim 5, wherein a first magnetic component of at least one of the first plurality of switching converters is magnetically coupled to a second magnetic component of at least one of the second plurality of switching converters.

7. The power conversion system of claim 4, further comprising an enclosure containing one or more of the first plurality of switching converters and one or more of the second plurality of switching converters.

8. The power conversion system of claim 4, wherein the first load is a high-voltage rechargeable energy storage system (RESS), wherein each of the plurality of first load elements includes one or more rechargeable battery cells, and wherein the second load is a low-voltage auxiliary power system.

9. The power conversion system of claim 8, further comprising:
one or more controllers in electrical communication with the first plurality of switching converters and the second plurality of switching converters, wherein the one or more controllers are programmed to:
control an operation of the first plurality of switching converters to transfer energy between the high-voltage RESS and the rectifier positive port and the rectifier negative port; and
control an operation of the second plurality of switching converters to transfer energy between the high-voltage RESS and the low-voltage auxiliary power system.

10. The power conversion system of claim 9, wherein the one or more controllers are further programmed to:
control the operation of the second plurality of switching converters to transfer energy between the plurality of first load elements of the high-voltage RESS to balance the high-voltage RESS.

11. A power conversion system for a vehicle, the power conversion system comprising:
a rectifier having a plurality of alternating current (AC) ports, a rectifier positive port, and a rectifier negative port, wherein the rectifier positive port and the rectifier negative port provide direct current (DC);
a first plurality of switching converters, wherein each of the first plurality of switching converters has a converter first positive port, a converter first negative port, a converter second positive port, and a converter second negative port, wherein the converter first positive port and the converter first negative port of all of the first plurality of switching converters are connected in series between the rectifier positive port and the rectifier negative port, and wherein each of the first plurality of switching converters is a transformer isolated DC/DC converter; and
a first load including a plurality of first load elements, wherein each of the plurality of first load elements has a load element positive port and a load element negative port, wherein the load element positive port and load element negative port of all of the plurality of first load elements are connected in series to form the first load, wherein the converter second positive port of at least one of the first plurality of switching converters is connected to the load element positive port of each of the plurality of first load elements, wherein the converter second negative port of at least one of the first plurality of switching converters is connected to the load element negative port of each of the plurality of first load elements, wherein the first load is a high-voltage rechargeable energy storage system (RESS), and wherein each of the plurality of first load elements includes one or more rechargeable battery cells.

12. The power conversion system of claim 11, further comprising
one or more controllers in electrical communication with the first plurality of switching converters, wherein the one or more controllers are programmed to:
control an operation of the first plurality of switching converters to transfer energy between the high-voltage RESS and the rectifier positive port and the rectifier negative port.

13. The power conversion system of claim 12, further comprising:
a second plurality of switching converters, wherein each of the second plurality of switching converters has a converter first positive port, a converter first negative port, a converter second positive port, and a converter second negative port, wherein the converter second positive port of at least one of the second plurality of switching converters is connected to the load element positive port of each of the plurality of first load elements, wherein the converter second negative port of at least one of the second plurality of switching converters is connected to the load element negative port of each of the plurality of first load elements, and wherein each of the second plurality of switching converters is a transformer isolated DC/DC converter; and
a second load, wherein the second load has a second load positive port and a second load negative port, wherein the converter first positive ports of all of the second plurality of switching converters are connected in parallel to the second load positive port of the second load, wherein the converter first negative ports of all of the second plurality of switching converters are connected in parallel to the second load negative port of the second load, and wherein the second load is a low-voltage auxiliary power system.

14. The power conversion system of claim 13, wherein the one or more controllers are further programmed to:
control an operation of the second plurality of switching converters to transfer energy between the high-voltage RESS and the low-voltage auxiliary power system.

15. The power conversion system of claim 14, wherein the one or more controllers are further programmed to:
control the operation of a first converter of the second plurality of switching converters to transfer energy between the plurality of first load elements of the high-voltage RESS at a first rate; and
control the operation of a second converter of the second plurality of switching converters to transfer energy between the plurality of first load elements of the high-voltage RESS at a second rate, wherein the second rate is different from the first rate.

16. The power conversion system of claim 15, wherein at least one of the first plurality of switching converters is magnetically coupled to at least one of the second plurality of switching converters using a multiple-winding isolation transformer.

17. The power conversion system of claim 16, further comprising an enclosure containing one or more of the first plurality of switching converters and one or more of the second plurality of switching converters.

18. A power conversion system for a vehicle, the power conversion system comprising:
a rectifier having a plurality of alternating current (AC) ports, a rectifier positive port, and a rectifier negative port, wherein the rectifier positive port and the rectifier negative port provide direct current (DC);
a first plurality of switching converters, wherein each of the first plurality of switching converters has a converter first positive port, a converter first negative port, a converter second positive port, and a converter second negative port, wherein the converter first positive port and the converter first negative port of all of the first plurality of switching converters are connected in series between the rectifier positive port and the rectifier negative port, and wherein each of the first plurality of switching converters is a transformer isolated DC/DC converter;
a first load including a plurality of first load elements, wherein each of the plurality of first load elements has a load element positive port and a load element negative port, wherein the load element positive port and load element negative port of all of the plurality of first load elements are connected in series to form the first load, wherein the converter second positive port of at least one of the first plurality of switching converters is connected to the load element positive port of each of the plurality of first load elements, wherein the converter second negative port of at least one of the first plurality of switching converters is connected to the load element negative port of each of the plurality of first load elements, wherein the first load is a high-voltage rechargeable energy storage system (RESS), and wherein each of the plurality of first load elements includes one or more rechargeable battery cells;
a second plurality of switching converters, wherein each of the second plurality of switching converters has a converter first positive port, a converter first negative port, a converter second positive port, and a converter second negative port, wherein the converter second positive port of at least one of the second plurality of switching converters is connected to the load element positive port of each of the plurality of first load elements, wherein the converter second negative port of at least one of the second plurality of switching converters is connected to the load element negative port of each of the plurality of first load elements, and wherein each of the second plurality of switching converters is a transformer isolated DC/DC converter; and
a second load, wherein the second load has a second load positive port and a second load negative port, wherein the converter first positive ports of all of the second plurality of switching converters are connected in parallel to the second load positive port of the second load, wherein the converter first negative ports of all of the second plurality of switching converters are connected in parallel to the second load negative port of the second load, and wherein the second load is a low-voltage auxiliary power system.

19. The power conversion system of claim 18, further comprising
one or more controllers in electrical communication with the first plurality of switching converters, wherein the one or more controllers are programmed to:
control an operation of the first plurality of switching converters to transfer energy between the high-voltage RESS and the rectifier positive port and the rectifier negative port;
control an operation of the second plurality of switching converters to transfer energy between the high-voltage RESS and the low-voltage auxiliary power system; and
control the operation of the second plurality of switching converters to transfer energy between the plurality of first load elements of the high-voltage RESS to balance the high-voltage RESS.

20. The power conversion system of claim 19, wherein a first magnetic component of at least one of the first plurality of switching converters is magnetically coupled to a second magnetic component of at least one of the second plurality of switching converters.
